(19) United States
(12) Patent Application Publication
(10) Pub. No.: US 2018/0012291 A1
(43) Pub. Date: Jan. 11, 2018

(54) Physical Product Display-Based Apparatus

(71) Applicant: Wal-Mart Stores, Inc., Bentonville, AR (US)

(72) Inventors: Aaron J. Vasgaard, Rogers, AR (US); Matthew A. Jones, Bentonville, AR (US); Robert J. Taylor, Rogers, AR (US)

(21) Appl. No.: 15/643,561

(22) Filed: Jul. 7, 2017

Related U.S. Application Data
(60) Provisional application No. 62/360,102, filed on Jul. 8, 2016.

(51) Int. Cl. G06Q 30/06

(52) U.S. Cl. CPC G06Q 30/0643; G06Q 30/0639; G06Q 30/0627; G06Q 30/0641

(57) ABSTRACT

A retail shopping facility has a plurality of physical product displays where at least some of the physical product displays simultaneously display a plurality of different available items. A central computer system is configured to receive from a mobile device a customer message from a customer. This message includes information that identifies at least a portion of a particular one of the physical product displays (such as an empty part of the display). The central computer system is also configured to transmit to that mobile device a reply message that includes a pictorial depiction that corresponds to the aforementioned portion of this particular physical product display.

### CROSS-REFERENCE TO RELATED APPLICATION

This application claims the benefit of U.S. Provisional Application No. 62/360,102, filed Jul. 8, 2016, which is incorporated herein by reference in its entirety.

### TECHNICAL FIELD

These teachings relate generally to physical product displays and in particular to product displays that are located at retail shopping facilities.

### BACKGROUND

In a modern retail store environment, there is a need to improve the customer experience and/or convenience for the customer. With increasing competition from non-traditional shopping mechanisms, such as online shopping provided by e-commerce merchants and alternative store formats, it can be important for “bricks and mortar” retailers to focus on improving the overall customer experience and/or convenience.

A typical presentation/shopping paradigm at a retail store includes physical product displays. Examples include shelves of various kinds, tabletops, bins, racks, cabinets, endcaps, and so forth. A typical physical product display will often simultaneously display a plurality of different available items. Usually such a display includes multiple copies of each available item. So configured, a customer can purchase one of the displayed items by physically selecting and removing the desired item from the display and paying for the removed item at a point of sale (POS) station.

Sometimes demand exceeds the available supply. When that happens the corresponding physical product display may have an empty area where a sold-out item was previously located. When the enterprise anticipates restocking that display within some reasonable amount of time, the empty area may be left temporarily vacant pending such restocking.

Empty spaces on physical product displays, however, can vex a customer in any number of ways. Not only may the current unavailability of the item frustrate the customer's intent to purchase that item, the customer may also be unable to address any number of other concerns that physical examination of the item might have resolved. For example, the customer might have questions regarding the size or configuration of the item's packaging, the ingredients that comprise the item, and so forth.

### BRIEF DESCRIPTION OF THE DRAWINGS

The above needs are at least partially met through provision of the physical product display-based apparatus described in the following detailed description, particularly when studied in conjunction with the drawings, wherein:

FIG. 1 comprises a block diagram as configured in accordance with various embodiments of these teachings;

FIG. 2 comprises a call flow diagram as configured in accordance with various embodiments of these teachings;

FIG. 3 comprises a perspective view as configured in accordance with various embodiments of these teachings; and

FIG. 4 comprises a schematic screen shot view as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments include a retail shopping facility having a plurality of physical product displays where at least some of the physical product displays simultaneously display a plurality of different available items. A central computer system is configured to receive from a mobile device a customer message from a customer. This message includes information that identifies at least a portion of a particular one of the physical product displays (such as an empty part of the display). The central computer system is also configured to transmit to that mobile device a reply message that includes a pictorial depiction that corresponds to the aforementioned portion of this particular physical product display.

The aforementioned identifying information can serve, for example, to directly or indirectly identify a particular item that is not presently available at that display. Examples in these regards include optical codes (such as stock keeping unit (SKU) numbers) and non-optical codes (such as radio-frequency identification (RFID) codes). The identifying information may also include, in lieu of the foregoing or in combination therewith, a captured image of the relevant part of the physical product display.

The aforementioned pictorial depiction in the replay message can vary with the needs and/or opportunities that tend to characterize a given application setting. By one approach the pictorial depiction comprises a captured image. By another approach the pictorial depiction comprises an artistic rendering.

By one approach the pictorial depiction in the reply message is configured to be overlaid on an image of the physical product display itself to thereby form a composite image on the display of the customer mobile device that includes both of the depictions. So configured, the customer can visually compare a “fully stocked” depiction of the physical product display with the “as is” depiction to identify and discern the missing item (or items).

These teachings are highly flexible in practice and will accommodate a wide variety of modifications and embellishments. By one approach, for example, the reply message can also include other product description information regarding an item that is missing from the physical product display. Examples of such product description information include a listing of ingredients for the item, information regarding a product family of items that corresponds to the missing item, information regarding various sizes and/or versions of the item that is missing, and so forth.

In lieu of the foregoing or in combination therewith these teachings will also accommodate including in the reply message information regarding alternative locations where the missing item might be presently located (for example, elsewhere in this retail sales facility or elsewhere at another store), information regarding substitute items that might suffice in lieu of the missing item, and so forth.

So configured, a customer's needs and expectations can be more fully met even when the item being sought by the customer is not presently available where expected.

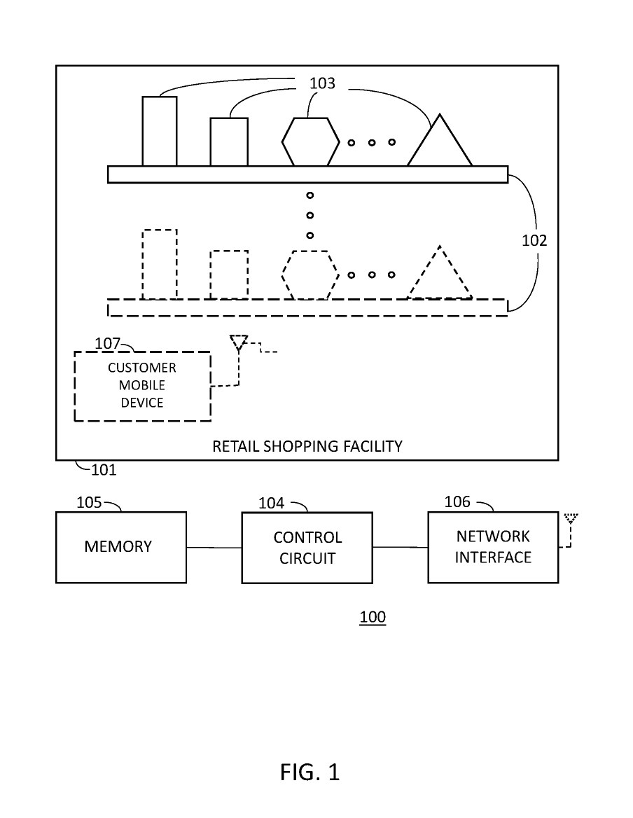

These and other benefits may become clearer upon making a thorough review and study of the following detailed description. Referring now to the drawings, FIG. 1 presents an illustrative example of an enabling apparatus 100 that generally accords with these teachings.

This apparatus 100 includes a retail shopping facility 101 having at least one and likely a plurality of physical product displays 102 that each simultaneously display a plurality of different available items 103 (“available” in that the items are physically present and a customer may physically select and purchase the item). The retail shopping facility 101 comprises a retail sales facility or any other type of bricks-and-mortar (i.e., physical) facility in which products are physically displayed and offered for sale to customers who physically visit the facility. The shopping facility may include one or more of sales floor areas (which likely include the aforementioned physical product displays 102), checkout locations (i.e., point of sale (POS) locations), customer service areas other than checkout locations (such as service areas to handle returns), vehicular parking locations, entrance and exit areas, stock room areas, stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

These teachings will accommodate a wide variety of types and form factors (i.e., shapes) for the physical product displays 102 including but not limited to shelves, tabletops, bins, end-caps, and so forth. These physical product displays 102 can have any of a variety of sizes and can be formed of any suitable material (including, for example, metal, plastic, paperboard, wood, and so forth). There is no requirement that all (or even any) of the plurality of physical product displays 102 be identical or even similar to one another in any of these regards. Part or all of any particular physical product display 102 may be refrigerated and/or illuminated or not as desired.

These teachings will similarly accommodate a wide variety of displayed items 103. Examples include both perishable and nonperishable items and items having virtually any imaginable size, form factor, and/or material composition.

In this illustrative example the apparatus 100 also includes a central computer system comprising, in this example, a control circuit 104 and various corresponding components. Being a “circuit,” the control circuit 104 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 104 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 104 is configured (for example, by using corresponding programming as will be well understood by those skilled in the art) to carry out one or more of the steps, actions, and/or functions described herein.

By one optional approach the control circuit 104 operably couples to a memory 105. This memory 105 may be integral to the control circuit 104 or can be physically discrete (in whole or in part) from the control circuit 104 as desired. This memory 105 can also be local with respect to the control circuit 104 (where, for example, both share a common circuit board, chassis, power supply, and/or housing) or can be partially or wholly remote with respect to the control circuit 104 (where, for example, the memory 105 is physically located in another facility, metropolitan area, or even country as compared to the control circuit 104).

In addition to information that, for example, correlates radio-frequency identification (RFID) tags and/or SKU numbers with products and/or customers, this memory 105 can serve, for example, to non-transitorily store the computer instructions that, when executed by the control circuit 104, cause the control circuit 104 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 104 also operably couples to a network interface 106. So configured the control circuit 104 can communicate with other elements (both within the apparatus 100 and external thereto) via the network interface 106. Network interfaces, including both wireless and non-wireless platforms, are well understood in the art and require no particular elaboration here.

Part or all of this central computer system can be physically housed within the aforementioned retail shopping facility 101 or not as desired. These teachings will also accommodate, for example, using one or more of the components of the central computer system to provide the services described herein to more than one such retail shopping facility if desired.

As will be described in more detail below, these teachings presume the availability and use of at least one customer mobile device 107. Examples include but are not limited to cellular telephones, tablet/pad-styled computers and laptop computers. Such devices may be owned by the customers themselves or may be provided for the customer's temporary in-facility use by (or on behalf of) the enterprise that operates the retail shopping facility 101. Such devices may be portable and readily carried by the customer in their hands or may, for example, comprise shopping cart-mounted devices.

Generally speaking, in addition to a display (which may preferably but not necessarily comprise a touch-screen display) and camera, the customer mobile device 107 will also include at least one wireless communications transceiver. The wireless communications transceiver permits the customer mobile device 107 to wirelessly communicate (for example, with the aforementioned control circuit 104 either directly or indirectly via the aforementioned network interface 106) using, for example, data telephony services, Wi-Fi services, Bluetooth services, and so forth as appropriate to a given application setting. As such details are well known in the art, no further elaboration in these regards appears here for the sake of clarity and brevity.

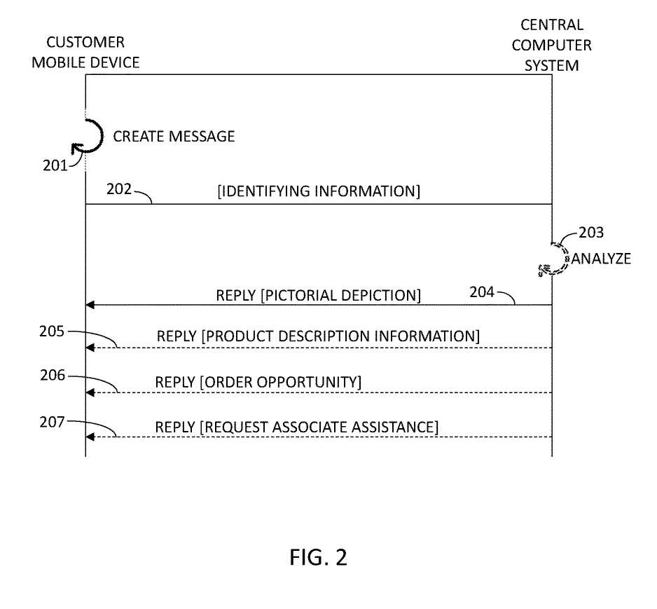

FIG. 2 presents an illustrative manner for employing and leveraging the foregoing apparatus 100. Pursuant to this example the customer's mobile device 107 creates a message (at 201) and transmits that message 202 to the central computer system (in particular, the aforementioned control circuit 104). In a typical application setting the mobile device 107 will be responding to a direct or indirect command or instruction input by the customer. The customer, in turn, may be instigating these events in response to discovering that the product they are seeking appears to be absent from the location where the customer expected to find the product.

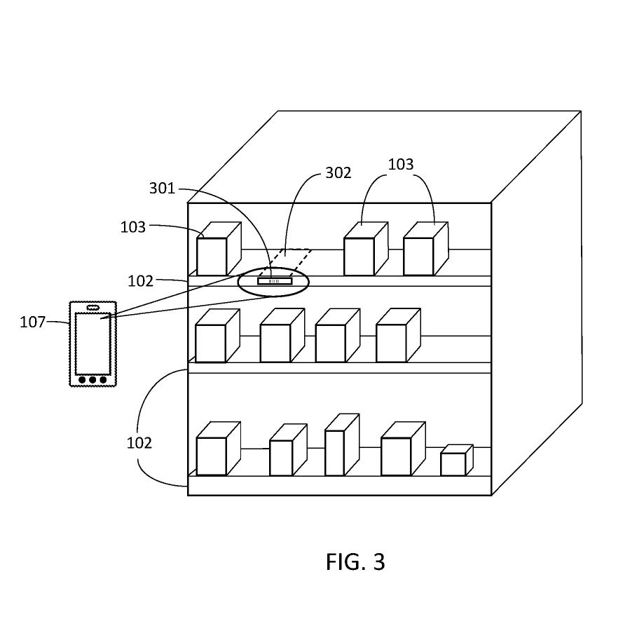

This message 202 includes information that identifies at least a portion of a particular one of the physical product displays 102. Referring momentarily to FIG. 3, by one approach the customer's mobile device 107 acquires this identifying information by capturing an image of an optical code 301 (such as a universal product code (UPC) barcode) that is presented on the physical product display 102 in common with the aforementioned portion of interest. By another approach the identifying information can simply comprise a captured image of the physical product display 102 itself. In all of these cases the mobile device 107 may be responding to the customer's instruction/command to capture the relevant image.

If desired, the aforementioned identifying information can comprise or further include identifying information that identifies a particular item that is not available at the particular one of the physical product displays 102. With continued reference to FIG. 3, the aforementioned optical code 301 can provide such identifying information for a particular item that is not available at the adjacent shelf space 302. In that case, the identifying information can comprise, for example, a stock keeping unit (SKU) number for the missing item. These teachings will accommodate other approaches in these regards however. For example, the customer's mobile device 107 may include an RFID-tag reader that can read identifying information provided by a corresponding RFID tag that corresponds to the missing item, in which case the identifying information in the message 202 can include, for example, a unique RFID identifier (such as an EPCGlobal serial number).

As noted above, the customer's mobile device 107 might simply capture one or more images of the relevant part of the physical product display 102 using an on-board camera. Such an image could depict, for example, a relevant empty space 302 on the physical product display 102 and an item 103 on one side (or both sides) of the empty space 302. It may also be useful in some application settings for such an image to also include a view of the physical product display 102 that is above and/or below the physical product display 102 of interest.

Upon receipt of that message 202, and as denoted at reference numeral 203 in FIG. 2, the control circuit 104 of the central computer system can analyze the message 202 to glean, for example, the aforementioned item or items of identifying information. When the identifying information simply comprises an image (or images) as described above, for example, this analysis can comprise analyzing the captured image(s) to identify at least one item 103 that does not appear in the captured image but which should appear in the captured image (presuming that the physical product display 102 were fully and appropriately stocked). By way of a simple illustration, and again presuming the example of FIG. 3, the control circuit 104 could compare the received image of the physical product display 102 that includes the empty space 302 with one or more stored images of that physical product display 102 when fully stocked to identify the item (or items) that are absent in the received image.

Referring again to FIG. 2, the control circuit 104 of the central computer system can then responsively transmit a reply message 204 to the customer's mobile device 107 that includes a pictorial depiction that corresponds to the particular portion of the physical product display 102 of concern to the customer. As one useful example in these regards the pictorial depiction can include a depiction of an item 103 that is missing from this particular physical product display 102 and which should be present when the display is fully stocked.

These teachings are quite flexible and will accommodate various approaches in these regards. For example, if desired that pictorial depiction can comprise, at least in part, a captured image (i.e., an image of the actual physical item as captured with a camera or the like). By another approach, the pictorial depiction can comprise, at least in part, an artistic rendering (accomplished using a digital medium and/or hand-held artist's tools such as pencils, pens, paint brushes, and so forth).

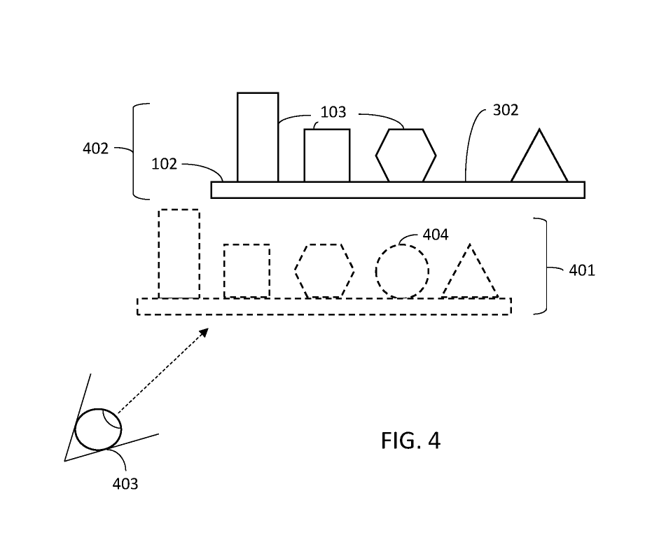

By one approach, and referring momentarily to FIG. 4, the pictorial depiction can comprise an image 401 that is configured to be overlaid on an image 402 of the physical product display 102 of interest such that a customer 403 viewing the overlaid result on the display of the customer mobile device 107 views a composite image that includes both the physical product display 102 of interest and the pictorial depiction provided by the control circuit 104. To facilitate distinguishing one from the other, if desired, the transmitted image 401 can have some measure of transparency (for example, 75% transparent, 50% transparent, 25% transparent, or some other desired level of transparency) such that the underlying image 402 will nevertheless be at least partially visible through the transmitted image 401.

So configured, the customer 403 will be able to readily discern and identify the item 404 in the transmitted image 401 that should occupy the empty space 302 in the current image 402 of the physical product display 102. Accordingly, the customer 403 can then be readily and intuitively informed about what item is presently missing in the display.

In addition to the above-described pictorial depiction, the control circuit 104 can optionally transmit other information of interest to the customer mobile device 107 if and as desired. As one example in these regards, the control circuit 104 can transmit, as an additional reply 205 (which may be communicatively part of the original reply 204 or which may be a separate communication transaction as desired), product description information regarding the missing item. As one simple example in these regards the product description information can comprise information regarding ingredients for the missing item. As another simple example the product description information can comprise information regarding items in a product family of items that includes the missing item. As yet another simple example the product description information can comprise information regarding various sizes and/or versions of the missing item.

As other examples in these regards, information regarding the product can include information regarding an alternative location for the missing item (either at the retail shopping facility 101 or at an alternative retail shopping facility that currently stocks the missing item) as well as information regarding a substitute item (such as a different brand) for the missing item that is available and that the customer might find satisfactory.

In lieu of the foregoing or in combination therewith the control circuit 104 can transmit a supplemental reply message 206 that includes an opportunity to order the missing item. This opportunity can comprise, for example, an on-line ordering service via which the customer can order the missing item. In this case, if desired, the customer can also be provided with the opportunity to select delivery of the item to a customer-specified address or, if desired, the customer can be provided with the opportunity to select an in-store pickup at a future date.

Also in lieu of the foregoing or in combination therewith the control circuit 104 can transmit a supplemental reply message 207 that includes an opportunity to request associate assistance at the physical product display 102 of interest. This opportunity may include the ability to summon an associate to visit the display and conduct a face-to-face in-person verbal exchange with the customer at the display. This opportunity may also include the ability to conduct a remote dialogue with the associate (via a voice or data link, for example, where the latter permits text messaging or the like).

So configured, a customer who cannot locate a particular item may nevertheless be able to learn what they wish to learn about the product and may also be able to conveniently locate and/or purchase the item or a satisfactory substitute notwithstanding that current appearance of unavailability. These teachings can be economically fielded and can be implemented in a way that requires very little supplemental training for the customer.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a retail shopping facility having a plurality of physical product displays where at least some of the physical product displays simultaneously display a plurality of different available items;
a central computer system configured to:
receive from a mobile device a customer message from a customer, the message including information that identifies at least a portion of a particular one of the physical product displays;
transmitting to the mobile device a reply message that includes a pictorial depiction that corresponds to the portion of the particular one of the physical product displays.

2. The apparatus of claim 1 wherein the customer message includes identifying information identifying a particular item as not being available at the particular one of the physical product displays.

3. The apparatus of claim 2 wherein the identifying information comprises a stock keeping unit (SKU) number.

4. The apparatus of claim 2 wherein the identifying information comprises a unique radio-frequency identification (RFID) identifier.

5. The apparatus of claim 2 wherein the identifying information comprises a captured image of the particular one of the physical product displays.

6. The apparatus of claim 5 wherein the central computer system is further configured to:
analyze the captured image to identify at least one item that does not appear in the captured image but which should appear in the captured image.

7. The apparatus of claim 1 wherein the pictorial depiction comprises, at least in part, a captured image.

8. The apparatus of claim 1 wherein the pictorial depiction comprises, at least in part, an artistic rendering.

9. The apparatus of claim 1 wherein the pictorial depiction comprises, at least in part, an image configured to be overlaid on an image of the particular one of the physical product displays such that the customer viewing an overlaid result views a composite image that includes both the particular one of the physical product displays and the pictorial depiction.

10. The apparatus of claim 9 wherein the pictorial depiction includes a depiction of an item that is missing from the particular one of the physical product displays but which should be present in the particular one of the physical product displays.

11. The apparatus of claim 10 wherein the reply message further includes product description information regarding the item that is missing from the particular one of the physical product displays.

12. The apparatus of claim 11 wherein the product information comprises information regarding ingredients for the item that is missing from the particular one of the physical product displays.

13. The apparatus of claim 11 wherein the product information comprises information regarding items in a product family of items that includes the item that is missing from the particular one of the physical product displays.

14. The apparatus of claim 13 wherein the product family of items comprises various sizes and/or versions of the item that is missing from the particular one of the physical product displays.

15. The apparatus of claim 11 wherein the product information comprises information regarding an alternative location for the item that is missing from the particular one of the physical product displays elsewhere in the retail shopping facility.

16. The apparatus of claim 11 wherein the product information comprises information regarding a substitute item for the item that is missing from the particular one of the physical product displays.

17. The apparatus of claim 11 wherein the product information comprises information regarding an alternative retail shopping facility that currently stocks the item that is missing from the particular one of the physical product displays.

18. The apparatus of claim 1 wherein the reply message includes an opportunity to order the item that is missing from the particular one of the physical product displays.

19. The apparatus of claim 18 wherein the opportunity to order the item that is missing from the particular one of the physical product displays includes an opportunity to select delivery to a customer-specified address.

20. The apparatus of claim 1 wherein the reply message includes an opportunity to request associate assistance at the particular one of the physical product displays.
